(19) United States
(12) Patent Application Publication
(10) Pub. No.: US 2015/0135872 A1
(43) Pub. Date: May 21, 2015

(54) IMPACT SWITCHING DEVICE OF AN IMPACT DRILL GEARBOX

(71) Applicant: DONGGUAN BEST ELECTRIC TOOLS CO., LTD., Dongguan City (CN)

(72) Inventors: Qiang WANG, Dongguan City (CN); Yi-Tung CHIU, Dongguan City (CN)

(21) Appl. No.: 14/338,668

(22) Filed: Jul. 23, 2014

(30) Foreign Application Priority Data
Nov. 15, 2013 (CN) 201320718999.4

(51) Int. Cl. F16H 3/78

(52) U.S. Cl. CPC F16H 3/78
USPC 74/333

(57) ABSTRACT

An impact switching device of an impact drill gearbox includes a gearbox front shell, an output shaft, a torque regulating mechanism, an impact mechanism, a decelerating mechanism and a gear shifting mechanism. The gearbox front shell on its top is prominently mounted with threaded columns. The gear shifting mechanism includes a function switching loop, a circular adjustment screw, a gear shifting gasket and stop posts. The adjustment screw is in thread connection to the threaded columns. The stop posts are connected to the gearbox front shell. The lower ends of the stop posts are connected with the decelerating mechanism. The gear shifting gasket is slidingly connected to the gearbox front shell along the vertical direction. The upper end face of the gear shifting gasket is prominently provided with position-limiting bosses.

### FIELD OF THE INVENTION

The present invention relates to the impact drill technology field, and more especially, to an impact switching device of an impact drill gearbox.

### BACKGROUNG OF THE INVENTION

In general, the existing impact drills have the following several working modes: electric drill, electric screwdriver and impact drill. When using the screwing gear, the control gear must be adjusted at the screwing gear, in which case, the impact bit will decide when to shift the gear according to the screwing gear torque setting, while in gear shifting, the rotary motor of the impact bit keeps rotating, but the screwdriver keeps stationary, so that the impact bit cannot output the maximum torque. When using the electric drilling gear, the rotary motor and the front-end bit keep the same action all the time, outputting the maximum torque and maintaining no gear shifting. When using the impact drilling gear, except retaining of the original electric drilling gear function, the impact mechanism will be started up at the same time to provide impact action, which can drill cement wall or other hard objects more effectively. To achieve the possibility of operation and adjustment for various demands, in general, an impact switching device will be designed between the rotary motor and the front-end fitting, so as to realize the need for operation adjustment on machinery and provide a control interface for the user to set the impact drilling.

The existing double-cup impact switching device includes a gearbox front shell, an output shaft through the gearbox front shell, a torque regulating mechanism on the top of the gearbox front shell, an impact mechanism arranged on the output shaft, a decelerating mechanism at the bottom of the gearbox front shell, and a gear shifting mechanism connected between the torque regulating mechanism and the decelerating mechanism, wherein the bottom of the output shaft is connected with the decelerating mechanism, the gearbox front shell on its top is prominently mounted with threaded columns, and the gear shifting mechanism generally switches the functions of screwing, electric drilling and impact by switching the gear shifting gasket, however, due to irrational structure of the existing gear shifting mechanisms, the gear shifting gasket may abrade the function regulating ring when jumping up and down under the screwing gear, which may affect the utilization of the function regulating ring and thus cause poor function switching effect.

### SUMMARY OF THE INVENTION

The present invention aims at providing an impact switching device with simple structure and good function switching effect which adopts thread regulation to achieve function switching effect in view of the disadvantages in the prior art.

To realize the purpose above, the present invention adopts the following technical solution: an impact switching device of an impact drill gearbox, including a gearbox front shell, an output shaft through the gearbox front shell, a torque regulating mechanism on the top of the gearbox front shell, an impact mechanism arranged on the output shaft, a decelerating mechanism at the bottom of the gearbox front shell, and a gear shifting mechanism connected between the torque regulating mechanism and the decelerating mechanism, wherein the bottom of the output shaft is connected with the decelerating mechanism, the gearbox front shell on its top is prominently mounted with threaded columns, and the gear shifting mechanism includes a function switching loop rotationally encasing the gearbox front shell, a circular adjustment screw which rotates by the driving of the function switching loop, a gear shifting gasket below the adjustment screw, and stop posts which slide vertically by the driving of the function switching loop, wherein the adjustment screw is grooved with inner threads on its internal surface, through which the adjustment screw is in thread connection to the threaded columns, the stop posts are slidingly connected to the gearbox front shell along the vertical direction, the lower ends of the stop posts are connected with the decelerating mechanism, the gear shifting gasket is slidingly connected to the gearbox front shell along the vertical direction, the upper end face of the gear shifting gasket is prominently provided with position-limiting bosses, and on the bottom of the adjustment screw are prominently and downwards arranged with position-limiting protruded posts corresponding to the position-limiting bosses.

The position-limiting bosses are arranged on one side with position-limiting recesses receiving the position-limiting protruded posts.

The gear shifting gasket on its upper end face is circumferentially and evenly equipped with a plurality of position-limiting bosses.

The function switching loop is vertically mounted with guide slots on its internal surface, and the adjustment screw is peripherally and prominently provided with guide posts, which are slidingly connected into the guide slots.

The function switching loop is equipped with guide slopes on its internal surface, and the stop posts press against the guide slopes.

The stop posts are prominently configured with a guide protrusion on one side of the top, and the bottom of the guide protrusion is arc structured and presses against the guide slope.

Compression springs are fitted between the top of the stop posts and the torque regulating mechanism.

The decelerating mechanism includes a third-layer internal gear for connection to the stop posts, a plurality of balls are provided between the top of the third-layer internal gear and the bottom of the gear shifting gasket, the third-layer internal gear is peripherally and prominently arranged with a plurality of stop blocks, and the bottom of the stop posts extends to the outside of the circumferential external surface of the third-layer internal gear and lies between the stop blocks.

The third-layer internal gear is grooved with an arc track groove on its upper end face, the bottom of the balls presses against the arc track groove, and on the upper end face of the third-layer internal gear, a plurality of slope pushing parts which can lift the balls upwards to project circumferentially and regularly.

The beneficial effect of the present invention is: the impact switching device of an impact drill gearbox provided by the present invention includes a gearbox front shell, an output shaft, a torque regulating mechanism, an impact mechanism, a decelerating mechanism and a gear shifting mechanism, wherein the bottom of the output shaft is connected with the decelerating mechanism, the gearbox front shell on its top is prominently mounted with threaded columns, and the gear shifting mechanism includes a function switching loop, a circular adjustment screw, a gear shifting gasket and stop posts, wherein the adjustment screw is in thread connection to the threaded columns, the stop posts are slidingly connected to the gearbox front shell along the vertical direction, the lower ends of the stop posts are connected with the decelerating mechanism, the gear shifting gasket is slidingly connected to the gearbox front shell along the vertical direction, the upper end face of the gear shifting gasket is prominently provided with position-limiting bosses, and on the bottom of the adjustment screw are prominently and downwards arranged with position-limiting protruded posts corresponding to the position-limiting bosses. The present invention can lead the adjustment screw to rise and fall spirally along the threaded columns by rotating the function switching loop, so as to adjust the relative position of the position-limiting protruded posts and the position-limiting bosses for realizing switching of different functions, and meanwhile, prevent the impact switching device via the stop posts from gear shifting under electric drilling and impact drilling gears but enable it to shift gear automatically under the screwing gear. The present invention adopts thread regulation to achieve function switching, in which the gear shifting gasket and the function switching loop are not directly connected so that the gear shifting gasket will not abrade the function switching loop, exhibiting simple structure, simple and convenient operation and good function switching effect.

### BRIEF DESCRIPTION OF THE DRAWINGS

FIG. 1 is the sectional view of the present invention;

FIG. 2 is the sectional view of the present invention from another angle;

FIG. 3 is the schematic view of the structure of the gear shifting mechanism according to the present invention;

FIG. 4 is the schematic view of the structure of the gear shifting mechanism according to the present invention from another angle;

FIG. 5 is the exploded view of the gear shifting mechanism of the present invention;

FIG. 6 is the schematic view of the structure of the present invention when switching to the screwing gear;

FIG. 7 is the schematic view of the structure of the present invention when switching to the electric drilling gear; and

FIG. 8 is the schematic view of the structure of the present invention when switching to the impact drilling gear.

### DETAILED DESCRIPTION OF THE PREFERRED EMBODIMENTS

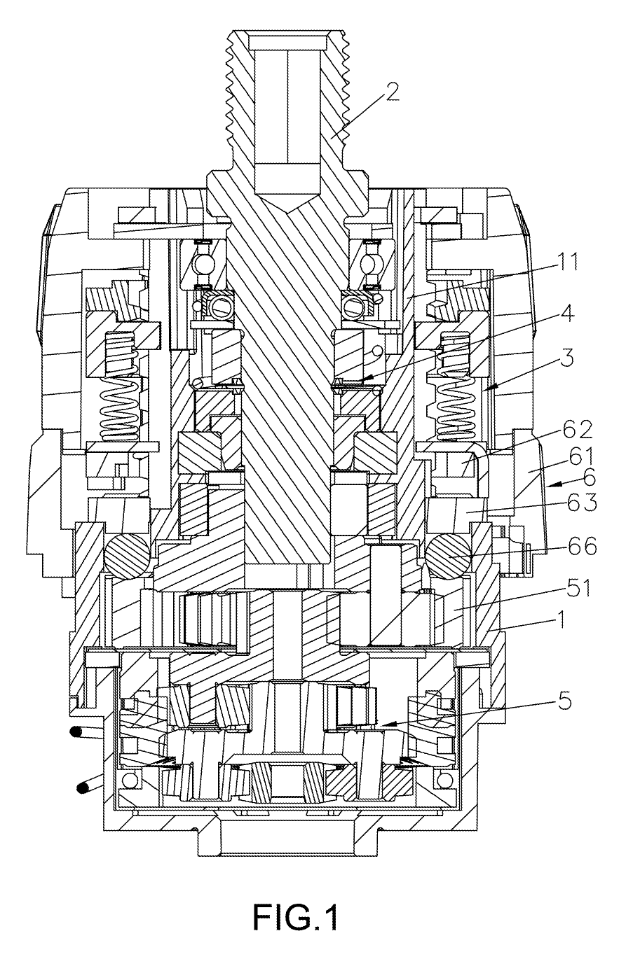

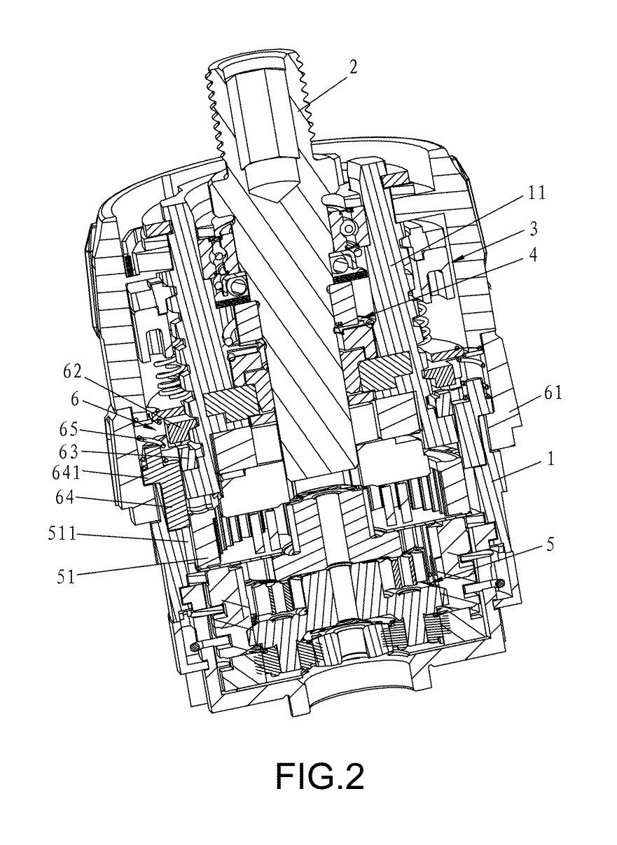

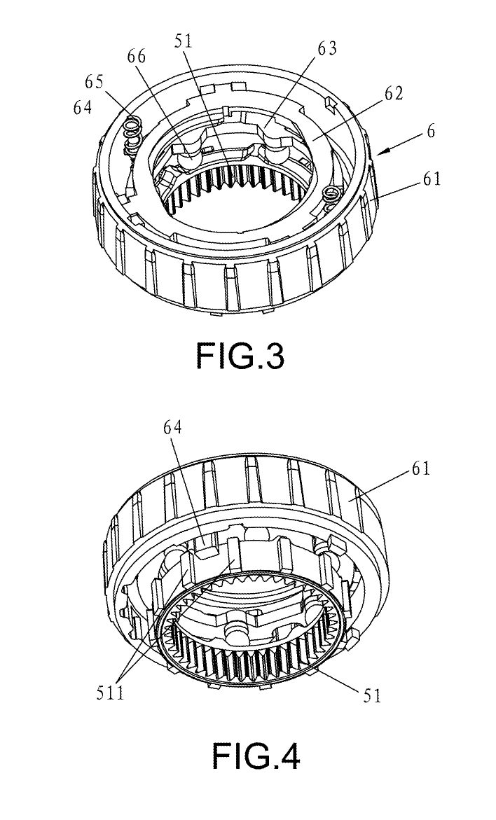

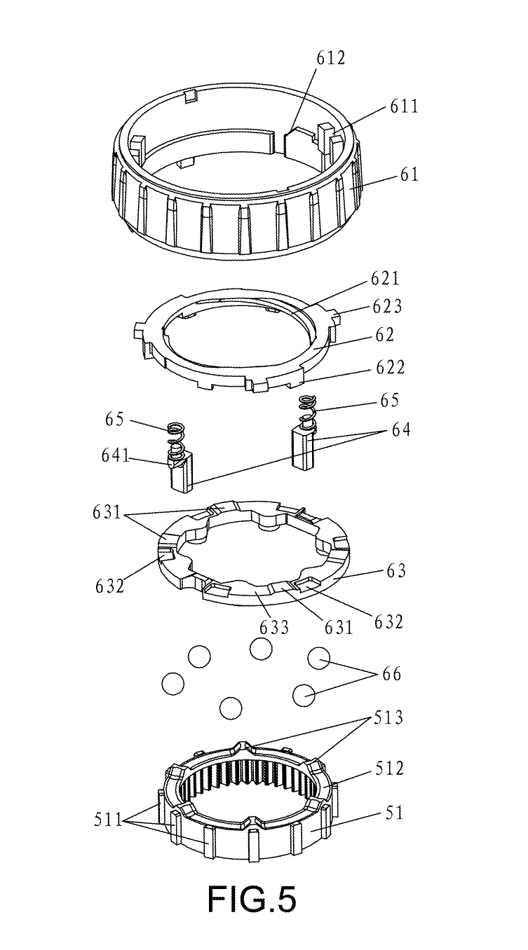

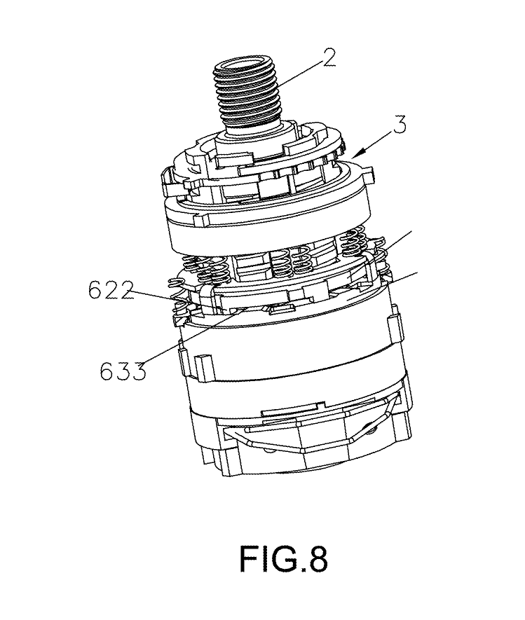

The present invention will be further illustrated in combination with the drawings. As shown in FIG. 1-8, the present invention includes a gearbox front shell 1, an output shaft 2 through the gearbox front shell 1, a torque regulating mechanism 3 on the top the gearbox front shell 1, an impact mechanism 4 arranged on the output shaft 2, a decelerating mechanism 5 at the bottom of the gearbox front shell 1, and a gear shifting mechanism 6 connected between the torque regulating mechanism 3 and the decelerating mechanism 5, wherein the bottom of the output shaft 2 is connected with the decelerating mechanism 5, the gearbox front shell 1 on its top is prominently mounted with threaded columns 11, and the gear shifting mechanism 6 includes a function switching loop 61 rotationally encasing the gearbox front shell 1, a circular adjustment screw 62 which rotates by the driving of the function switching loop 61, a gear shifting gasket 63 below the adjustment screw 62, and stop posts 64 which slide vertically by the driving of the function switching loop 61, wherein the adjustment screw 62 is grooved with inner threads 621 on its internal surface, through which the adjustment screw 62 is in threaded connection to the threaded columns 11, the stop posts 64 are slidingly connected to the gearbox front shell 1 along the vertical direction, the lower ends of the stop posts 64 are connected with the decelerating mechanism 5, the gear shifting gasket 63 is slidingly connected to the gearbox front shell 1 along the vertical direction, the upper end face of the gear shifting gasket 63 is prominently provided with position-limiting bosses 631, on the bottom of the adjustment screw 62 are prominently and downwards arranged with position-limiting protruded posts 622 corresponding to the position-limiting bosses 631, and the position-limiting bosses 631 and both of their sides correspond to different gear positions respectively.

The present invention can lead the adjustment screw 62 to rise and fall spirally along the threaded columns 11 by rotating the function switching loop 61, so as to adjust the relative position of the position-limiting protruded posts 622 and the position-limiting bosses 631 for realizing switching of different functions, and meanwhile, prevent the impact switching device via the stop posts 64 from gear shifting under electric drilling and impact drilling gears but enable it to shift gear automatically under the screwing gear. The present invention adopts thread regulation to achieve function switching, in which three gears including screwdriver, electric drill and impact drill can be switched when rotating the function switching loop 61, and the gear shifting gasket 63 and the function switching loop 61 are not directly connected so that the gear shifting gasket 63 will not abrade the function switching loop 61, exhibiting simple structure, simple and convenient operation and good function switching effect.

The position-limiting bosses 631 are arranged on one side with position-limiting recesses 632 receiving the position-limiting protruded posts 622, wherein when the position-limiting protruded posts 622 of the adjustment screw 62 rotate to positions corresponding to the position-limiting recesses 632, there is space between the position-limiting protruded posts 622 and the position-limiting recesses 632 for the gear shifting gasket 63 to move up and down axially, the positions of the position-limiting recesses 632 and the position-limiting bosses 631 correspond to those of the screwing gear and the electric drilling gear respectively, the positions of the other side of the position-limiting bosses 631 form position-limiting planes 633, which correspond to the position of the impact drilling gear, and the gear shifting gasket 63 on its upper end face is circumferentially and regularly equipped with a plurality of position-limiting bosses 631.

The function switching loop 61 is vertically mounted with guide slots 611 on its internal surface, and the adjustment screw 62 is peripherally and prominently provided with guide posts 623, which are slidingly connected into the guide slots 611, and for the simple structure, the rotation of the function switching loop 61 will lead the adjustment screw 62 to rotate and move up and down.

The function switching loop 61 is equipped with guide slopes 612 on its internal surface, and the stop posts 64 press against the guide slopes 612. When rotating the function switching loop 61, the stop posts 64 can be led to move up and down by the pushing of the guide slopes 612. The stop posts 64 are prominently configured with a guide protrusion 641 on one side of the top, and the bottom of the guide protrusion 641 is arc structured and presses against the guide slope 612, which reduces the friction between the guide protrusion 641 and the guide slope 612. Compression springs 65 are fitted between the top of the stop posts 64 and the torque regulating mechanism 3, which can push back continuously the force for the stop posts 64 to go downwards, thus enabling the stop posts 64 to reset downwards automatically.

The decelerating mechanism 5 includes a third-layer internal gear 51 for connection to the stop posts 64, a plurality of balls 66 are provided between the top of the third-layer internal gear 51 and the bottom of the gear shifting gasket 63, and the third-layer internal gear is peripherally and prominently arranged with a plurality of stop blocks 511. When the impact switching device switches to electric drilling and impact gears, the bottom of the stop posts 64 extends to the outside of the circumferential external surface of the third-layer internal gear 51 and lies between the stop blocks 511, clamping the third-layer internal gear 51, so as to prevent it from rotation for realization of no gear shifting; when the impact switching device is under the screwing gear, the stop blocks 511 and the third-layer internal gear 51 are separated.

The third-layer internal gear 51 is grooved with an arc track groove 512 on its upper end face, the bottom of the balls 66 presses against the arc track groove 512, the arc track groove 512 leads the balls 66 to prevent the latter from moving, and on the upper end face of the third-layer internal gear 51, a plurality of slope pushing parts 513 which can lift the balls 66 upwards to project circumferentially and regularly. When the third-layer internal gear 51 rotates to the position where the slope pushing parts 513 press against the balls 66, the third-layer internal gear 51 can rotate after overcoming the pressure of the balls 66, thus realizing gear shifting.

I. Screwdriving Function

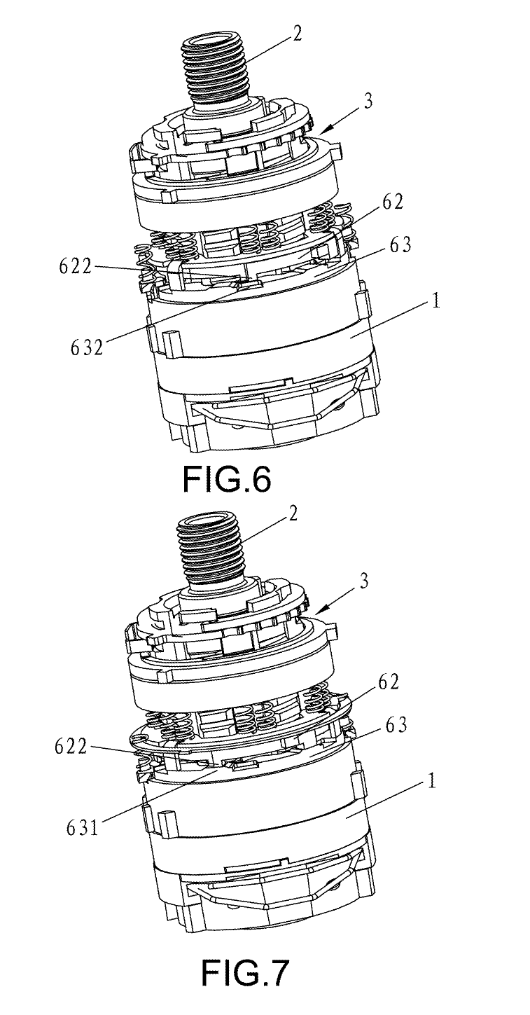

As shown in FIG. 6, when the function switching loop 61 is adjusted at the position of the screwing gear, the position-limiting protruded posts 622 of the adjustment screw 62 correspond to the position-limiting recesses 632 of the gear shifting gasket 63, so as to enable the gear shifting gasket 63 to move up and down axially when under the pressure of the balls 66, meanwhile, affected by the shape of the guide slopes 612 inside the function switching loop 61, the stop posts 64 are forced to move upwards and keep separated from the third-layer internal gear 51, so that the third-layer internal gear 51 can rotate after overcoming the pressure of the balls 66, thus realizing the gear shifting function required for the screwing gear.

II. Electric Drilling Function

As shown in FIG. 6, when the function switching loop 61 is adjusted at the position of the electric drilling gear, the position-limiting protruded posts 622 of the adjustment screw 62 press against the position-limiting bosses 631 of the gear shifting gasket 63, the adjustment screw 62 is limited by the threads and cannot move up or down, which disables the gear shifting gasket 63 to move up or down axially as well, and the gear shifting gasket 63 prevents the third-layer internal gear 51 from rotation via the balls 66, thus realizing no gear shifting under the electric drilling gear, meanwhile, affected by the shape of the guide slopes 612 inside the function switching loop 61 and the compression spring 65, the stop posts 64 are forced to move downwards and combine with the third-layer internal gear 51, so as to prevent the third-layer internal gear 51 from rotation, thus realizing no gear shifting under the electric drilling gear.

III. Impact Drilling Function

As shown in FIG. 6, when the function switching loop 61 is adjusted at the position of the impact gear, the position-limiting protruded posts 622 of the adjustment screw 62 press against the position-limiting planes 633 on the other side of the position-limiting bosses 631 which lie on the gear shifting gasket 63, the adjustment screw 62 is limited by the threads and cannot move up or down, which disables the gear shifting gasket 63 to move up or down axially as well, and the gear shifting gasket 63 prevents the third-layer internal gear 51 from rotation via the balls 66, thus realizing no gear shifting under the impact drilling gear, meanwhile, affected by the shape of the guide slopes 612 inside the function switching loop 61 and the compression spring 65, the stop posts 64 are forced to move downwards and combine with the third-layer internal gear 51, so as to prevent the third-layer internal gear 51 from rotation, thus realizing no gear shifting under the impact drilling gear.

Obviously, the description above is only to illustrate the preferred embodiments of the present invention, thus any equivalent variation or modification based on the structure, characteristics and principle described in the present invention shall be all covered by the protection scope of the present invention.

What is claimed is:

1. An impact switching device of an impact drill gearbox, including a gearbox front shell (1), an output shaft (2) through the gearbox front shell (1), a torque regulating mechanism (3) on the top of the gearbox front shell (1), an impact mechanism (4) arranged on the output shaft (2), a decelerating mechanism (5) at the bottom of the gearbox front shell (1), and a gear shifting mechanism (6) connected between the torque regulating mechanism (3) and the decelerating mechanism (5), wherein the bottom of the output shaft (2) is connected with the decelerating mechanism (5), the gearbox front shell (1) on its top is prominently mounted with threaded columns (11), and the gear shifting mechanism (6) includes a function switching loop (61) rotationally encasing the gearbox front shell (1), a circular adjustment screw (62) which rotates by the driving of the function switching loop (61), a gear shifting gasket (63) below the adjustment screw (62), and stop posts (64) which slide vertically by the driving of the function switching loop (61), wherein the adjustment screw (62) is grooved with inner threads (621) on its internal surface, through which the adjustment screw (62) is in thread connection to the threaded columns (11), the stop posts (64) are slidingly connected to the gearbox front shell (1) along the vertical direction, the lower ends of the stop posts (64) are connected with the decelerating mechanism (5), the gear shifting gasket (63) is slidingly connected to the gearbox front shell (1) along the vertical direction, the upper end face of the gear shifting gasket (63) is prominently provided with position-limiting bosses (631), and on the bottom of the adjustment screw (62) are prominently and downwards arranged with position-limiting protruded posts (622) corresponding to the position-limiting bosses (631).

2. The impact switching device of an impact drill gearbox according to claim 1, wherein the position-limiting bosses (631) are arranged on one side with position-limiting recesses (632) receiving the position-limiting protruded posts (622).

3. The impact switching device of an impact drill gearbox according to claim 1, wherein the gear shifting gasket (63) on its upper end face is circumferentially and regularly equipped with a plurality of position-limiting bosses (631).

4. The impact switching device of an impact drill gearbox according to claim 1, wherein the function switching loop (61) is vertically mounted with guide slots (611) on its internal surface, the adjustment screw (62) is peripherally and prominently provided with guide posts (623), which are slidingly connected into the guide slots (611).

5. The impact switching device of an impact drill gearbox according to claim 1, wherein the function switching loop (61) is equipped with guide slopes (612) on its internal surface, and the stop posts (64) press against the guide slopes (612).

6. The impact switching device of an impact drill gearbox according to claim 1, wherein the stop posts (64) are prominently configured with a guide protrusion (641) on one side of the top, and the bottom of the guide protrusion (641) is arc structured and presses against the guide slope (612).

7. The impact switching device of an impact drill gearbox according to claim 1, wherein compression springs (65) are fitted between the top of the stop posts (64) and the torque regulating mechanism (3).

8. The impact switching device of an impact drill gearbox according to claim 1, wherein the decelerating mechanism (5) includes a third-layer internal gear (51) for connection to the stop posts (64), a plurality of balls (66) are provided between the top of the third-layer internal gear (51) and the bottom of the gear shifting gasket (63), the third-layer internal gear (51) is peripherally and prominently arranged with a plurality of stop blocks (511), and the bottom of the stop posts (64) extends to the outside of the circumferential external surface of the third-layer internal gear (51) and lies between the stop blocks (511).

9. The impact switching device of an impact drill gearbox according to claim 8, wherein the third-layer internal gear (51) is grooved with an arc track groove (512) on its upper end face, the bottom of the balls (66) presses against the arc track groove (512), and on the upper end face of the third-layer internal gear (51), a plurality of slope pushing parts (513) which can lift the balls (66) upwards to project circumferentially and regularly.
